(19) United States
(12) Patent Application Publication
(10) Pub. No.: US 2006/0076217 A1
(43) Pub. Date: Apr. 13, 2006

(54) Conveyor belt training idler roller assemblies

(76) Inventor: Douglas John Cumberlege, Port Elizabeth (ZA)

Correspondence Address: MEYERTONS, HOOD, KIVLIN, KOWERT & GOETZEL, P.C., P.O. BOX 398, AUSTIN, TX, 78767-0398, US

(21) Appl. No.: 10/551,145

(22) PCT Filed: Mar. 19, 2004
(86) PCT No.: PCT/IB04/00812

§ 371 Date: Sep. 22, 2005

(30) Foreign Application Priority Data
Mar. 27, 2003 (ZA) 2003/2368

(51) Int. Cl. B65G 39/16

(52) U.S. Cl. 198/806

(57) ABSTRACT

A training idler roller assembly is provided in which the idler roller (6) is adapted to slew in a plane generally parallel to that of the conveyor belt (3) to move one or other ends of the roller (6) in the general direction of travel of the conveyor belt so guide the belt to return to the central desired position in the event that it drifts laterally. An idler roller unit (6) is compose of one or more idler rollers (1, 26) mounted for free rotation on one or more axles (4) with the idler roller unit having a suspension formation (13) associated with each end thereof whereby the end of the idler roller unit may be supported relative to a conveyor structure (17, 19).

### FIELD OF THE INVENTION

This invention relates to a conveyor belt training idler roller assembly of the type in which the idler roller is adapted to slew about a pivot axis generally transverse to the plane of the conveyor belt in order to steer the belt back towards a central position on the idler roller when the belt tends to drift laterally to one or other side of its intended conveyor path.

On one hand, the invention is concerned with a conveyor belt training idler roller that can be used most effectively in conveyor belt installations in which the relevant section of the belt extends in a generally horizontal direction, typically at an inclination of not greater than about 25 or 30 degrees to the horizontal. On the other hand, the invention is also concerned with a somewhat different conveyor belt training idler that can be used effectively on steeply inclined sections of conveyor belt

### BACKGROUND TO THE INVENTION

It is well known in the art that a conveyor belt generally requires some form of steering facility for returning it to a central position on its support rollers whenever it tends to drift laterally to one or other side of a desired path of movement during operation. Various expedients have been proposed and implemented in order to achieve this.

Some of these employ arrangements that engage the edges of the conveyor belt in order to physically urge the conveyor belt inwards to a central position whenever it drifts away from such a central position. These are considered by applicant to be undesirable, especially in the food industry, as a result of the fact that the edges of the conveyor belt can become frayed or damaged relatively rapidly. In the food industry, the damaged areas can allow bacteria to set in, and the conveyor belt must, accordingly, be replaced.

Other devices generally tend to fall into one of two general categories. The first is that of relatively complex devices in which the position of the edge of a conveyor belt is employed to activate a steering mechanism for a conveyor belt idler roller in a direction so that the belt returns to the centre of the roller. For this purpose, the edge of the belt may be continuously monitored either optically, for example using optical fibres or infrared radiation, or electronically. In this case sophisticated pneumatic, hydraulic, or electrical steering mechanisms are activated to impart movement to the training idler roller to counteract the lateral drift of the conveyor belt.

Alternatively, a somewhat more simple mechanical arrangement may be utilized in which auxiliary sensor rollers are activated by the edge of a belt as it drifts towards one side or the other and the contact between the edge of the belt and the sensor rollers translates into a positive mechanical steering action of the training idler roller. These devices are typically mechanically complicated; are generally costly; and, often require significant maintenance in view of their complexity and additional components.

The other general category of training rollers is that of training idler rollers that are free to slew around a generally central transverse pivotal axis with the lateral movement of the belt itself being arranged to achieve the steering effect. As a general rule, such devices operate by virtue of increased drag that is occasioned when the belt moves towards one side of its desired path. It is with this category that the present invention is primarily concerned. For ease of reference this type of training idler roller will be referred to herein as a drag operated training idler roller.

One early arrangement in this category is described in U.S. Pat. No. 2,330,923 to Samuel D Robins. In this case a tubular training idler roller is pivotally mounted centrally of its length (in other words centrally across the width of the conveyor) by way of an internal bearing carried on a generally coaxial support shaft fixed to the conveyor structure so that the roller is capable of slewing, within limits, around an axis transverse, and in particular at right angles to, the conveyor belt that is being supported. The outer surface of the roller is crowned so that its outer diameter decreases from the centre of the roller towards each end. As a result of this shape drag at one side created by engagement of the belt with the roller surface tends to increase when the belt drifts laterally towards that end of the roller and this increased drag (and generally a decreased drag at the opposite side of the belt) slews the idler roller about the pivot axis. However, the single central bearing that supports the entire idler roller is, as far as applicant is concerned, mechanically unsound and therefore inclined to failure. Structurally it is difficult to effect and assemble.

Subsequent U.S. Pat. No. 5,911,304 describes a similar drag operated training idler roller with a somewhat improved bearing construction. Nevertheless, support of the roller is still ultimately at one central internal pivot and the construction and maintenance is somewhat difficult and costly when compared to a conventional idler roller. The idler roller in this case preferably has the crowned effect achieved by tapering the two ends of the outer surface of the roller as indicated in German patent DE3543255.

In order to avoid the use of the internal pivotal supports for such training idler rollers, various prior patents have used, with or without a steering mechanism, a central pivotal support that is positioned below the idler rollers themselves and, accordingly, below the conveyor belt. Typical of such constructions is that set out in U.S. Pat. No. 6,405,854. These general arrangements suffer from the disadvantage that the central pivotal support is located beneath the roller and, in particular in the case of the support of the return pass of a conveyor belt, dirt tends to fall from the conveyor belt onto the mechanism and may accumulate around the pivot.

In an apparent attempt to avoid a single central pivotal support, German patent DE899,622 proposes the support of the slewing training idler roller axle through elastomeric mounts at each end that attach it to the support structure. Applicant does not find this proposal attractive for a variety of reasons, not least of which is the fact that the slewing force required to operate the system increases significantly with increased deviation from a normal position.

Simply for completeness of disclosure of the present position, U.S. Pat. No. 6,173,830 and International patent applications publication numbers WO 03/068638 and WO 03/068639 describe alternative arrangements for creating drag to achieve a steering effect of such drag operated training idler rollers, these alternatives being a central band in the surface of the roller that has a lower coefficient friction with the belt than the two end regions of the roller and the provision of skid surfaces at the ends of the roller or outwards on laterally extending arms.

### OBJECT OF THE INVENTION

It is an object of this invention to provide a training idler roller assembly that is typically of the latter general type but that is differently supported in a simple yet effective manner that obviates at least some disadvantages that applicant perceives as being associated with the prior art indicated above.

### SUMMARY OF THE INVENTION

In accordance with this invention there is provided a training idler roller assembly comprising an idler roller unit that is adapted to be operatively mounted relative to a belt conveyor to extend transversely relative thereto and to support a region of the belt in a manner such that lateral drift of the belt from a central desired position on the idler roller unit towards one or other end thereof (side edge of the conveyor belt) causes the idler roller unit to slew in a plane generally parallel to that of the conveyor belt so as to move said one or other end in the general direction of travel of the conveyor belt and thereby guide the belt to return it to the said central desired position, and wherein an idler roller unit is composed of one or more idler rollers mounted for free rotation on one or more axles with the idler roller unit having a suspension formation associated with each end thereof whereby the end of the idler roller unit may be supported relative to a conveyor structure, the training idler roller assembly being characterized that in the suspension formation is, in each case, supported at an operatively lower end of a downwardly extending support arrangement that is attached to the conveyor structure at a position above the idler roller and conveyor belt supported thereby.

In a first variation of the invention the downwardly extending support arrangement is in the form of a separate pendulous arm at each end of the idler roller unit with the two pendulous arms being pivotally supported at or towards their operatively upper ends by the conveyor structure so that each is movable in a generally upright plane extending in the general direction of travel of the conveyor. The attachment of the idler roller unit to the conveyor structure by way of the pendulous arms is articulated at one or other position to a necessary extent to permit slewing of the idler roller unit relative to the conveyor structure.

Further features of this first variation of the invention provide for the pendulous arm in each case to be a plate pivotally mounted at its upper end so as to be rotatable in a generally vertical plane extending in the general direction of travel of the conveyor belt in which case the attachment of the idler roller unit to the arm is articulated to an extent necessary to accommodate the required slewing movement; for the idler roller unit to have an axle exposed at each end of the unit and configured to be supported in an accommodating aperture in the lower end region of the pendulous arm; and for the axle to have a pair of opposite, parallel and operatively generally vertical flat surfaces formed in an outer right circular cylindrical surface of a circular cross-sectioned axle in which case cooperating edges of the accommodating aperture cooperate with the flat surfaces to hold the associated end of the idler roller unit axially captive relative to the pendulous arm with a degree of play being provided to enable the necessary movement of the axle relative to the pendulous arm to take place in articulated manner.

In a second variation of the invention the downwardly extending support arrangement is in the form of a downwardly extending yoke having a central upper support pivot arrangement about which the yoke can slew about a generally vertical axis, and a pair of laterally spaced downwardly extending support arms to which the suspension formations of the idler roller unit are attached, typically in a manner similar to the attachment thereof to the individual pendulous arms.

A further feature of the second variation of the invention provides for the yoke to be of either simple inverted squat Y-shape supported centrally by a thrust bearing or the like adapted to support the weight of the yoke, roller and conveyor belt or, alternatively, an inverted U-shaped yoke supported centrally of the web of the U. In the latter case, it is also within the scope of this invention, that an elongate generally horizontal support rod or bar pass through a tubular web portion to the U-shaped yoke with a central pivot being positioned internally within the tubular web portion.

In its simplest form, the idler roller unit of the invention comprises a single idler roller supported on an axle by way of a bearing at or towards each end of the roller and the free ends of the axle are configured as indicated above to be supported by the downwardly extending support arrangement, typically in an aperture provided in a lower end of a pendulous arm carried by the associated conveyor structure in the case of the first variation of the invention or the laterally spaced support arms of the yoke assembly in the case of the second variation of the invention.

The idler roller or rollers and the idler roller unit embodying same preferably operates on the basis of a drag operated training idler roller and, to this end, the idler roller itself may be configured in any of the ways described in some detail in the prior art referred to above, the content of which is incorporated herein by reference. It is especially preferred, at the present time, that the idler roller have an external surface that tapers downwards towards each end thereof and it preferably tapers towards each end over the entire length of the roller from a central peripheral cylindrical band that can be used for branding or identification purposes. Nevertheless, any other of the expedients described as operating on the basic principle of drag could also be used, in the alternative, and some other appropriate steering mechanisms are described hereinafter.

In order that the above and other features of the invention may be more fully understood, various embodiments of the invention will now be described with reference to the accompanying drawings.

### BRIEF DESCRIPTION OF THE DRAWINGS

In the drawings:

FIG. 1 is a schematic plan view illustrating the general mode of operation of a training idler roller of the general type with which the invention is concerned;

FIG. 2 is a schematic perspective view of one embodiment of the first variation of the invention;

FIG. 3 is a sectional elevation of the embodiment of idler roller assembly illustrated in FIG. 2;

FIG. 4 illustrates, in enlarged end view, the pendulous arm assembly of the embodiment illustrated in FIG. 3;

FIG. 5 is a sectional elevation similar to FIG. 3 but illustrating two different alternatives;

FIG. 6 illustrates an embodiment of the invention in which the invention is applied to an idler roller unit for a troughed conveyor;

FIG. 7 illustrates a further alternative slew inducing means;

FIG. 8 illustrates a still further slew inducing means;

FIG. 9 illustrates on the left and the right-hand side thereof still further slew inducing means;

FIG. 10 illustrates in partial sectional elevation an embodiment of the second variation of the invention; and,

FIG. 11 illustrates, in elevation, a second embodiment of the second variation of the invention.

### DETAILED DESCRIPTION WITH REFERENCE TO THE DRAWINGS

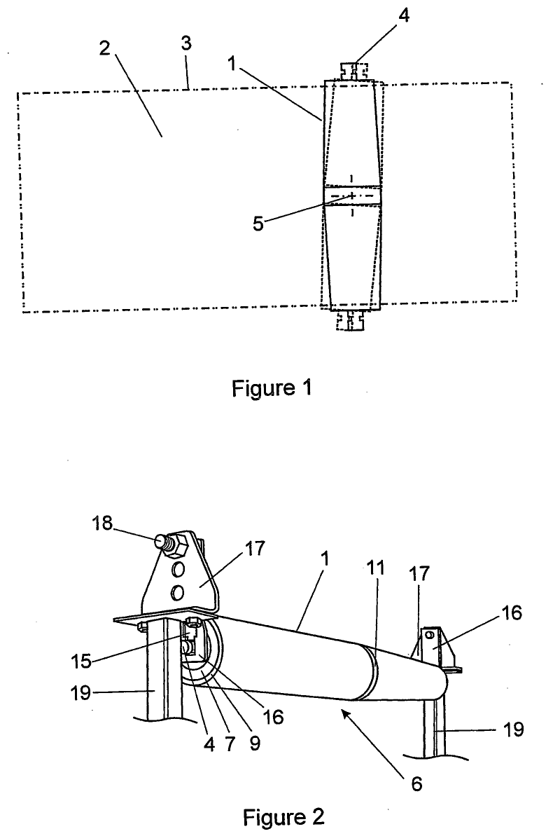

Referring firstly to FIGS. 1 to 4 of the drawings, a training idler roller according to the first aspect of the invention, generally indicated by numeral (1), may be introduced into a conveyor belt installation in either the forward pass or the return pass (2) of a conveyor belt (3). The training idler roller is freely rotatable on an axle (4).

As will be quite apparent to those skilled in the art, the idler roller is, in either event, installed between two freely rotatable conventional idler rollers supporting the conveyor belt and the construction of the conveyor belt assembly need not be described further herein. For purposes of illustration, the embodiment of the invention illustrated in FIGS. 1 to 4 may, by virtue of its configuration, be mounted to the upper forward pass of a conveyor belt.

As will be more fully described below, the training idler roller is mounted so that it may slew freely, within restricted limits, in a general plane that is parallel to the plane of the belt and that, in the case of the prior art, would have assumed the form of rotation about a fixed axis indicated by numeral (5). Thus, when the conveyor belt drifts towards one or other end of the idler roller (that is towards one or other side of the conveyor) the idler roller is subjected to unequal forces (drag) on each side of the centre of the conveyor and it slews in order to direct the conveyor belt back to a central position.

Reverting now more particularly to the embodiment of the invention illustrated in FIGS. 2 to 4, an idler roller unit, generally indicated by numeral (6), comprises a tubular roller (7) mounted towards each end by way of a bearing (8) onto the axle (4). The outer surface of the roller has an elastomeric layer (9) having an outer surface that tapers downwards over a major part of the distance from the centre of the length of the roller to the associated end (10). In this case a central peripheral cylindrical band (11) is provided on the outer surface of the elastomeric layer for purposes of identification or branding and the surface tapers downwards continuously and evenly from the band to the ends (10) of the roller.

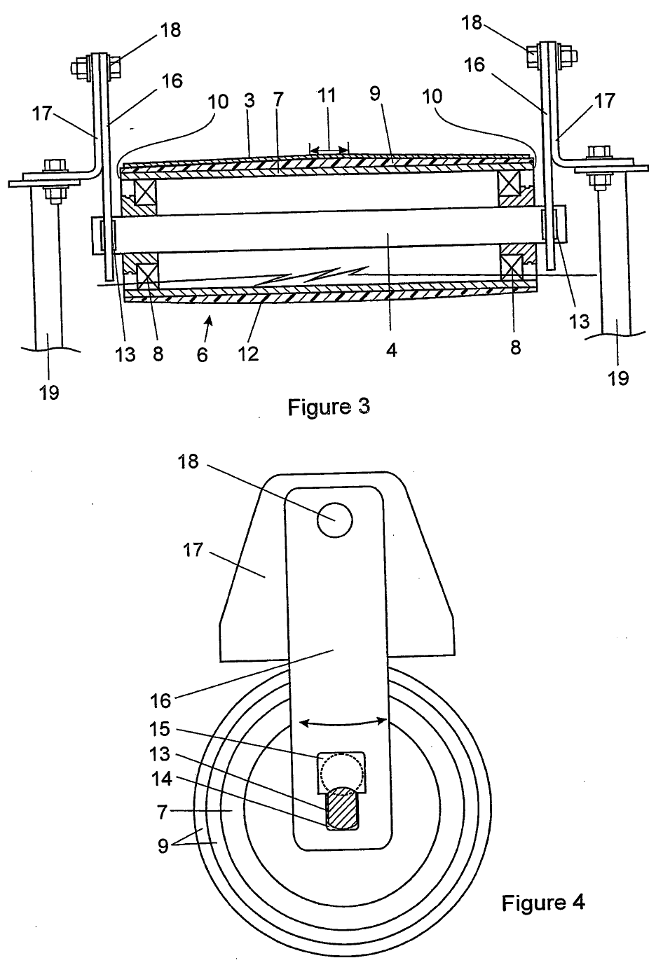

As one alternative to this, the outer surface could conform to a gently crowned shape as indicated by numeral (11) in the lower half of the section shown in FIG. 3, and as in the case of the roller described in U.S. Pat. No. 2,330,923 to Samuel D Robins.

In either event, each end of the axle that protrudes beyond the end of the roller has two diametrically opposite flat surfaces (13) formed therein so that a neck is formed that is accommodated captively between two generally vertical edges (14) of a lower part of an aperture (15) in the lower end region of a pendulous support arm (16) that is of plate-like configuration with gravity acting on the roller to maintain it in the lower part of the aperture. The upper part of the aperture is enlarged so that the axle can be lifted from between the two vertical edges (14) and removed axially from the aperture.

The upper end of the support arm (16) is pivotally attached to a bracket (17) by means of a horizontal pivot (18) and the bracket can be supported relative to a conveyor belt structure, in any suitable way, in the illustrated embodiment, at the upper end of support posts (19) (see FIG. 3). The axis of the pivot extends horizontally and at right angles to the length of the conveyor belt so that each support arm is freely rotatable in a generally vertical plane extending in the direction of the length of the conveyor belt.

The dimensioning or configuration of the aperture and the flat surfaces (13) is chosen such that sufficient free play is present to enable the axle (4) to slew relative to the support arm, at least to an adequate extent, to give effect to the following operation according to the invention.

With a conveyor belt (2) supported on the idler roller, the weight of the belt and roller will maintain the pendulous arms (16) in a generally vertical orientation and, whilst the belt is in the central desired position on the idler roller, directly opposite each other. However, when the belt drifts towards one side, the drag created between the belt and idler roller will increase on that side and the resultant force will pull that end region of the roller forwards in the direction of travel of the belt. This will, in turn, cause the pendulous arm to swing forwards, to some extent, with a resultant slewing of the roller. It will be understood that this can occur without the opposite end of the idler roller moving rearwards as is required in the case that a fixed pivot is present. The pendulous arms can thus move independently of each other.

The effect is very much the same as in the case of the prior art were a central pivot is provided but all the disadvantages associated with a central internal pivot positioned within the tubular roller, or below it, are avoided and the idler roller is supported in an extremely stable manner by the support arms at each end thereof. Nevertheless, the slewing effect is substantially the same in spite of the construction being extremely simple, comparatively speaking. Tests conducted thus far have indicated that the design of the support system described above can be implemented for not only fast moving heavy duty type industrial conveyors but also for slower moving more sensitive conveyors such as those utilized in the food industry, for example.

It is to be particularly noted that, because of its simple construction, and the fact that the idler roller can be of substantially conventional design and can be protected effectively against the ingress of dirt into the bearings, in known manner, maintenance is minimized. Even then, when maintenance is necessary, it is an extremely simple and quick operation to remove an idler roller unit from the swing arms and replace it.

The embodiment of the invention described above can be varied in numerous different ways as can the drag inducing expedient that causes a forward movement of the end of the idler roller towards which drifting of the conveyor belt takes place.

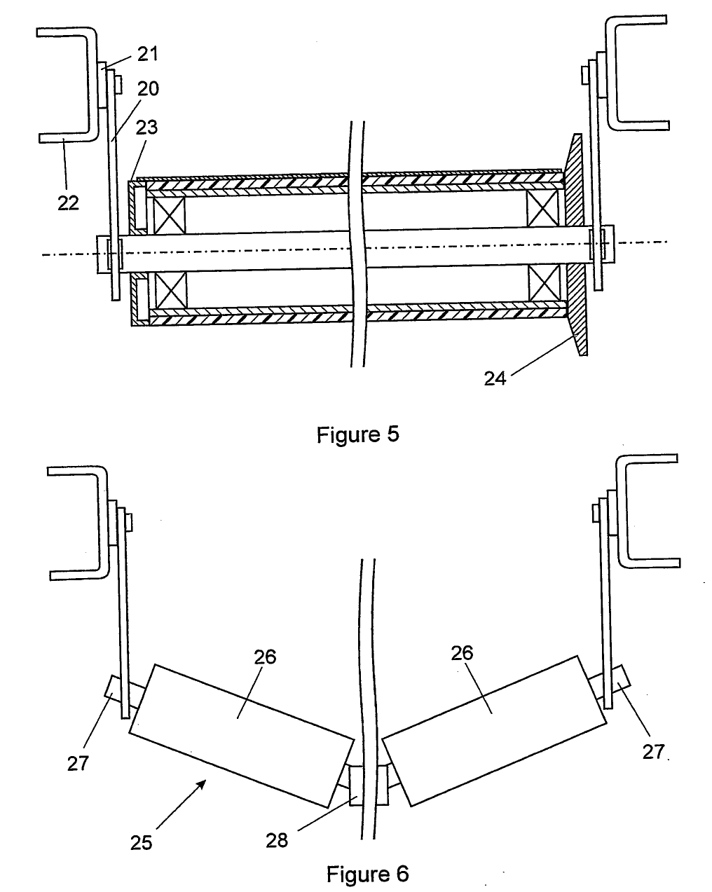

FIG. 5 illustrates a variation in which the pendulous arms (20) are attached to bearings (21) at their upper ends that are in turn carried directly by longitudinally extending channel shaped frame members (22) of the conveyor structure itself. This type of construction is particularly appropriate in instances in which the training idler roller is located beneath the forward pass of the conveyor belt and supports the return pass.

FIG. 5 also illustrates, at the left-hand side thereof, the use of skid disks (23) of the general nature described in international patent publication WO 03/068639 referred to above for effecting slewing, or contributing to the slewing effect of the idler roller. The right-hand side of FIG. 5 illustrates the use of a fixed tapered disc (24) for the purpose of effecting slewing of the idler roller.

FIG. 6 illustrates the application of the invention to a troughed idler roller unit (25), in this case consisting of two independently rotatable idler rollers (26) each carried on an axle (27), with the two axles being connected in the middle by a block (28) or the like.

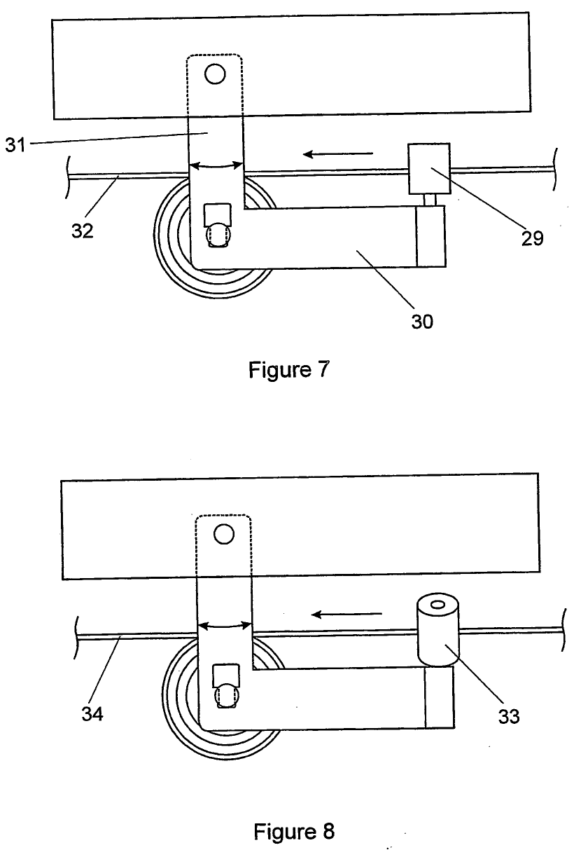

FIG. 7 illustrates the use of a jockey roller (29) rotatable about an upright axis and carried on a rearwardly projecting arm (30) that forms a horizontal extension to the vertical pendulous arm (31). The sole purpose of the jockey roller is to impose or enhance the slewing effect on the idler roller at the end thereof towards which an edge of the conveyor the (32) drifts, when that edge contacts the jockey roller.

FIG. 8 illustrates a similar situation, but one in which the jockey roller (33) is inclined so that the edge of the conveyor the (34) will tend to climb up the jockey roller in order to impose or enhance the slewing force on the idler roller.

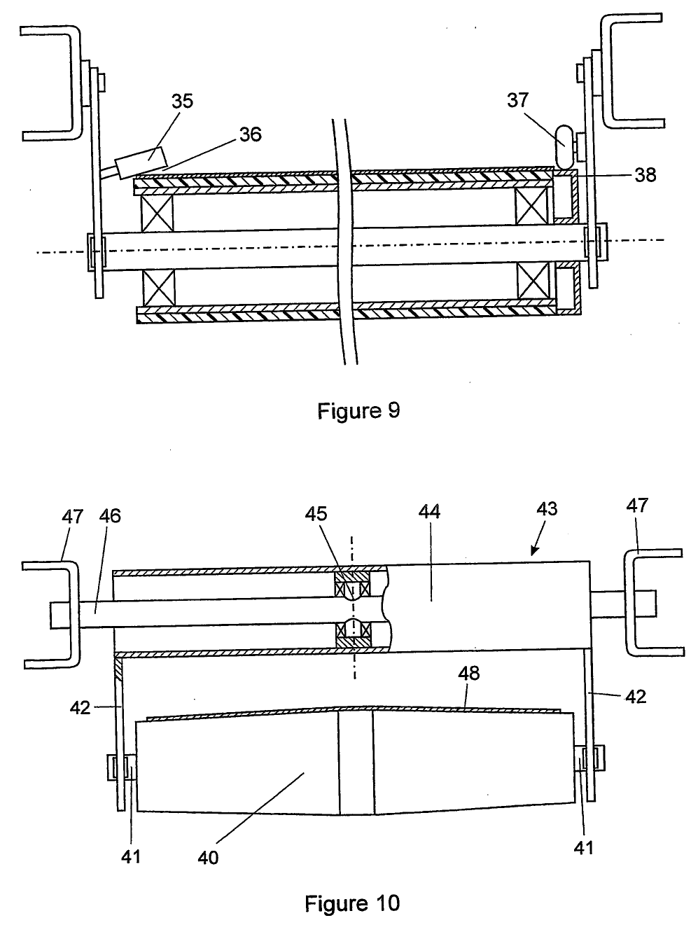

FIG. 9 illustrates, at the left-hand side, the use of an inclined jockey roller (35) that replaces the jockey roller (33) of FIG. 8 and, instead, is inclined oppositely so as to form a convergent nip (36) that the edge of the belt will enter when it drifts laterally and that will impose an appreciable drag on the belt and move forwards to achieve the steering effect described above. This variation of the drag generating means is considered to be particularly useful in instances in which it quick reaction to steer the conveyor that a central position is desired.

FIG. 9 also illustrates, on the right-hand side, a still further steering mechanism in the form of a pinch roller (37) that engages the surface of a stationary disc (38) of the type described with reference to FIG. 5. However, the pinch roller, greatly enhances the steering effect when the edge of a belt enters between the pinch roller and stationary disc to effect immediate corrective action by slewing of the idler roller.

Turning now to the second variation of the invention, FIG. 10 illustrates a first embodiment thereof in which an idler roller (40) is mounted on an axle (41) in the manner described above and the ends of the axle are supported in a manner similar to that described above by a pair of laterally spaced depending arms (42) of an inverted U-shaped yoke (43). The web (44) of the U-shaped yoke is tubular and is centrally supported by an internal pivot (45) so that the yoke and pivotable around a supporting transverse rod or bar (46) carried by the support structure (47) of a conveyor structure.

In use, slewing of the yoke around the pivot will take place in a manner that will be quite apparent those skilled in the art and that will be consequent on drag created between the belt and idler roller in any of the ways outlined above, or, indeed, in any other way. The advantage of the pivot being above the idler roller, and therefore above the conveyor belt (48) is that dirt falling off a conveyor belt will not the able to reach the pivot and the support assembly will be maintained in a substantially clean state compared to prior art types of installations.

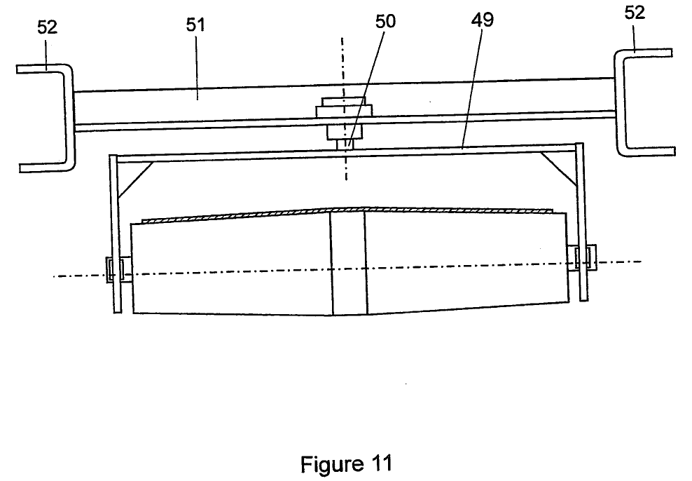

Referring now to FIG. 11, there is illustrated a second embodiment of the second variation of the invention in which the yoke (49) is of a basically inverted Y-shape with the stem of the Y being pivotally supported as indicated by numeral (50) by a transverse frame member (51) of a conveyor support structure (52). In use, this second embodiment will operate substantially similarly to that described above.

It is to be mentioned that the first variation of the invention generally finds greater application in generally horizontal stretches of conveyor belt whilst the second variation of the invention finds greater application in more steeply inclined conveyor belts.

The pendulous arms or yoke, as the case may be, may be made in numerous different ways. In particular, it is envisaged that the pendulous arms may be flexible or articulated in which case an articulated attachment of the arm to either or both of a supporting conveyor structure or the idler roller unit will be unnecessary.

Numerous other configurations of idler roller unit can be utilized in the implementation of this invention without departing from the scope hereof. Similarly, numerous different forms of pendulous support arm or yoke can be designed and the articulation of the support arms need not exclusively be at the lower end thereof where an idler roller unit is attached to pendulous arms as in the case described above. On the contrary, the upper end of the pendulous support arms could be supported in articulated manner, such as, for example, by means of a knuckle joint.

The invention therefore provides extremely effective and rather simple training idler roller assemblies that, in spite of their simplicity, nevertheless supports a steering idler roller unit in a more stable and effective manner than the fixed central pivots of the prior art.

1. A drag operated training idler roller assembly comprising:
an idler roller unit comprising:
at least one idler roller mounted for free rotation on at least one axle:
a suspension formation associated with each end of the idler roller unit; wherein an end of the idler roller unit is supported relative to a conveyor structure such that the idler roller unit is operatively mounted relative to a conveyor belt to extend transversely relative thereto and to support a region of the conveyor belt;
a downwardly extending support arrangement coupled to the conveyor structure at a position above the idler roller and the supported conveyor belt, the support arrangement comprising:
a support arm to which each suspension formation is attached, wherein the support arrangement in each case enables the support arm and suspension formations to slew in generally vertical planes extending in the general direction of travel of the conveyor belt;
and wherein lateral drift of the conveyor belt from a central desired position on the idler roller unit towards one or other end thereof causes the idler roller unit to slew in a plane generally parallel to that of the conveyor belt to move said one or other end in the general direction of travel of the conveyor belt so as to guide the conveyor belt to return to the said central desired position in response to increased drag between the conveyor belt and assembly of idler roller unit and support arrangement at or towards said one or other end thereof.

2. The training idler roller assembly as claimed in claim 1 in which the downwardly extending support arrangement comprises a separate pendulous arm at each end of the idler roller unit with the two pendulous arms being pivotally supported at or towards their operatively upper ends by the conveyor structure so that each pendulous arm is movable in a generally upright plane extending in the general direction of travel of the conveyor, the attachment of the idler roller unit to the conveyor structure by way of the pendulous arms being articulated to a necessary extent to permit slewing of the idler roller unit relative to the conveyor structure.

3. The training idler roller assembly as claimed in claim 2 in which the pendulous arm, in each case, is a plate pivotally mounted at its upper end so as to be rotatable in a generally vertical plane extending in the general direction of travel of the conveyor belt in which case the attachment of the idler roller unit to the arm is articulated to said necessary extent.

4. The training idler roller assembly as claimed in claim 2, in which the idler roller unit comprises an axle exposed at each end of the idler roller unit, and wherein the axle is configured to be supported in an accommodating aperture in lower end region of a pendulous supporting arm.

5. The training idler roller assembly as claimed in claim 4 in which the axle has a pair of opposite, parallel and operatively generally vertical flat surfaces formed in an outer right circular cylindrical surface of a circular cross-sectioned axle in which case cooperating edges of the accommodating aperture cooperate with the flat surfaces to hold the associated end of the idler roller unit axially captive relative to the pendulous arm with a degree of play being provided to enable the necessary articulated movement of the axle relative to the pendulous arm to take place.

6. The training idler roller assembly as claimed in claim 1 in which the downwardly extending support arrangement is in the form of a downwardly extending yoke having a central upper support pivot arrangement about which the yoke can slew about a generally vertical axis, and a pair of laterally spaced downwardly extending support arms to which the suspension formations of the idler roller unit are attached.

7. The training idler roller assembly as claimed in claim 6 in which the yoke is of an inverted squat Y-shape supported centrally by a thrust bearing or the like adapted to support the weight of the yoke, roller, and the conveyor belt.

8. The training idler roller assembly as claimed in claim 6 in which the yoke is of an inverted U-shape supported centrally by a web of the U-shape.

9. The training idler roller assembly as claimed in claim 8 in which an elongated, generally horizontal support rod or bar passes through a tubular web portion of the U-shaped yoke with a central pivot being positioned internally within the tubular web portion.

10. The training idler roller assembly as claimed in claim 1 in which the idler roller unit comprises a single idler roller supported on an axle by way of a bearing at or towards each end of the roller and wherein free ends of the axle are configured to be supported by a pendulous arm carried by the associated conveyor structure.

11. (canceled)

12. The training idler roller assembly as claimed in claim 10 in which the idler roller has an external surface that tapers downwards towards each end thereof.

13. The training idler roller assembly as claimed in claim 12 in which the external surface of the idler roller tapers towards each end over the entire length of the roller from a central cylindrical band in the outer surface thereof.
